(19) United States
(12) Patent Application Publication
(10) Pub. No.: US 2025/0178617 A1
(43) Pub. Date: Jun. 5, 2025

(54) IN-VEHICLE ELECTRONIC DEVICE

(71) Applicant: Hitachi Astemo, Ltd., Hitachinaka-shi, Ibaraki (JP)

(72) Inventor: Ryosuke HAYASHI, Hitachinaka-shi, Ibaraki (JP)

(73) Assignee: Hitachi Astemo, Ltd., Hitachinaka-shi, Ibaraki (JP)

(21) Appl. No.: 18/840,446

(22) PCT Filed: Apr. 26, 2022
(86) PCT No.: PCT/JP2022/018940

§ 371 Date: Aug. 21, 2024

(51) Int. Cl. B60W 50/029

(52) U.S. Cl. CPC B60W 50/029; B60W 2050/0297

(57) ABSTRACT

An in-vehicle electronic device connected to a plurality of calculation units mounted on a vehicle includes a communication unit that communicates with the plurality of calculation units, and a control unit that issues an instruction of substitution control to another calculation unit when an abnormality occurs in any one of the plurality of calculation units. When an abnormality occurs in the first calculation unit among the plurality of calculation units, the control unit acquires substitute capability information indicating whether the execution content of the first calculation unit can be substituted from another calculation unit.

### TECHNICAL FIELD

The present invention relates to an in-vehicle electronic device.

### BACKGROUND ART

A vehicle is mounted with an electronic control unit (ECU) which is one of the in-vehicle electronic devices, and the ECU controls each unit in the vehicle. A recent vehicle control system generally includes a plurality of ECUs.

When an abnormality occurs in the ECU, there is known a functional reconfiguration technique of substituting a function of the ECU with that of another ECU.

PTL 1 describes a technique for preventing a decrease in safety due to a sudden stop of a function in which continuity is emphasized, which is represented by automated driving, by transmitting a substitute program to a substitute control device before the occurrence of failure in order to improve immediacy of functional reconfiguration.

### CITATION LIST

### Patent Literature

PTL 1: JP 2017-092835 A

### SUMMARY OF INVENTION

### Technical Problem

As described above, a vehicle control system in recent years includes a plurality of ECUs, and the ECU itself is often mounted with a plurality of processors. Therefore, even when an abnormality occurs in one ECU, there are many cases where another ECU has a computational substitution capability, and by performing functional reconfiguration, it is possible to take over the function implemented by the failed ECU.

However, as described in PTL 1, in conventional technology, only one substitute program or degraded program is associated with one function. Therefore, the computational substitution capability cannot be sufficiently utilized, and the function or performance after the occurrence of abnormality is restricted more than necessary.

For this reason, there has been a demand for an in-vehicle electronic device capable of suppressing performance degradation after functional reconstruction.

### Solution to Problem

In order to solve the above problem, for example, the configuration described in the claims is adopted.

The present application includes a plurality of means for solving the above problem. As an example, an in-vehicle electronic device connected to a plurality of calculation units mounted on a vehicle includes a communication unit that communicates with the plurality of calculation units, and a control unit that issues an instruction of substitution control to a second calculation unit when an abnormality occurs in any one of the plurality of calculation units.

Then, when an abnormality occurs in the first calculation unit which is one of the plurality of calculation units, the control unit acquires substitute capability information indicating whether the second calculation unit can substitute the execution content of the first calculation unit.

### Advantageous Effects of Invention

According to the present invention, it is possible to identify and execute a calculation unit optimal for functional substitution by dynamically monitoring the substitute capability of the calculation unit such as an ECU. Therefore, even when an abnormality occurs in the calculation unit or the like, it is possible to prevent the comfort of the vehicle from degrading more than necessary.

Problems, configurations, and effects other than those described above will be clarified by the following description of embodiments.

### BRIEF DESCRIPTION OF DRAWINGS

FIG. 1 is a block diagram showing an example of a configuration of a substitution control determination device as an in-vehicle electronic device according to a first embodiment of the present invention.

FIG. 2 is a diagram showing an overview of a vehicle system having a vehicle control system according to the first embodiment of the present invention.

FIG. 3 is a configuration diagram showing an example of a network to which the in-vehicle electronic device according to the first embodiment of the present invention is connected.

FIG. 4 is a diagram showing an example of a configuration of a substitute program data table according to the first embodiment of the present invention.

FIG. 5 is a diagram showing an example of a configuration of a substitute capability data table according to the first embodiment of the present invention.

FIG. 6 is a flowchart showing an example of processing performed by the control unit according to the first embodiment of the present invention.

FIG. 7 is a flowchart showing an example of processing of determining a functional level and a distribution destination of the control unit according to the first embodiment of the present invention.

FIG. 8 is a flowchart showing an example of processing performed by the communication unit according to the first embodiment of the present invention.

FIG. 9 is a functional reconfiguration processing sequence according to the first embodiment of the present invention.

FIG. 10 is a diagram showing an operation mode/substitute program functional level correspondence according to a second embodiment of the present invention.

FIG. 11 is a flowchart showing an example of processing of determining a functional level and a distribution destination according to the second embodiment of the present invention.

FIG. 12 is a flowchart showing an example of processing performed by the communication unit according to the second embodiment of the present invention.

FIG. 13 is a functional reconfiguration processing sequence according to a third embodiment of the present invention.

FIG. 14 is a flowchart showing an example of processing performed by the control unit according to the third embodiment of the present invention.

### DESCRIPTION OF EMBODIMENTS

Hereinafter, embodiments of the present invention will be described in order. It should be noted that each embodiment described below shows a preferred example, and the present invention is not limited to each embodiment described below and can be implemented by appropriately adding, changing, or deleting the configuration of each unit without departing from the gist of the present invention.

In each embodiment below, a case where the present invention is applied to a vehicle control system will be described. In general, a system mounted on a vehicle often has limited resources, unlike an information processing system installed in a building such as a server. The resource here means the number and performance of central processing units (CPUs), the mounted memory capacity, and the like.

Due to the limited resources, the vehicle control system has to stop the function or significantly degrade the performance of the vehicle when an abnormality occurs, and there has been concern about a decrease in safety and comfort. Here, the vehicle control system according to the first embodiment of the present invention prevents, for example, a decrease in safety and comfort at the time of occurrence of an abnormality by the configuration and processing described below.

### First Embodiment

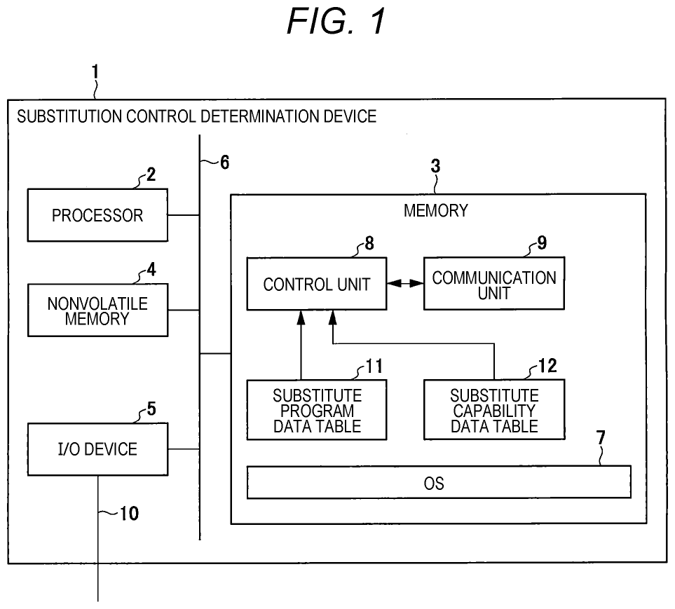

Hereinafter, an in-vehicle electronic device according to a first embodiment of the present invention will be described with reference to FIGS. 1 to 9.

FIG. 1 is a block diagram showing a substitution control determination device 1 constituting an in-vehicle electronic device according to a first embodiment.

The substitution control determination device 1 includes a processor 2, a memory 3, a nonvolatile memory 4, and an input/output (I/O) device 5. These processors 2 to I/O devices 5 are connected through an interconnect 6, and exchange data.

The I/O device 5 transmits and receives data to and from another apparatus connected by the network link 10 through the network link 10. As the network link 10, for example, a controller area network (CAN), a CAN with flexible data-rate (CANFD), Ethernet (registered trademark), or the like is used.

The memory 3 is loaded with an operating system (OS) 7, a control unit 8, a communication unit 9, a substitute program data table 11, and a substitute capability data table 12, which are executed and referred to by the processor 2. In the following description, for convenience, each unit will be described as an operation subject of processing, but an actual operation subject of each processing is the processor 2.

The control unit 8 and the communication unit 9 are software operating on the OS 7.

The substitution control determination device 1 configured as described above exchanges abnormality occurrence information of the ECU 13 (FIG. 3) and substitute capability information of the ECU 13 with the vehicle control system 20 connected via the network link 10 through the communication unit 9. The exchanged information is written in the substitute capability data table 12, and the control unit 8 is notified of the occurrence of abnormality via the communication unit 9. The control unit 8 reads and writes the substitute program data table 11 and the substitute capability data table 12, and determines an appropriate level of the substitute program and the ECU 13 to be the distribution destination thereof. Then, the control unit 8 distributes the substitute program to the determined ECU13.

It should be noted that the substitution control determination device 1 may be configured as a dedicated device, but one of the ECUs 13 described below may have a function as the substitution control determination device 1.

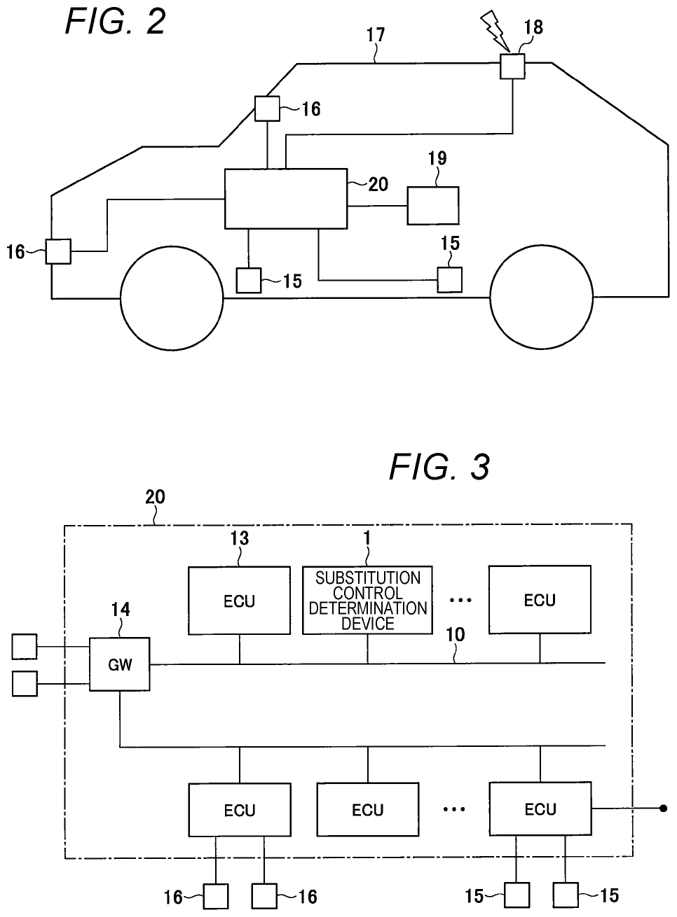

FIG. 2 shows an overview of a vehicle system 17 having a vehicle control system according to the present embodiment.

The vehicle system 17 includes a vehicle control system 20 inside an automobile or the like. The vehicle control system 20 here includes, for example, an in-vehicle network and an ECU.

The communication device 18 performs wireless communication with the outside of the vehicle system 17. For example, the communication device 18 performs communication using a protocol such as mobile phone communication, a local area wireless network (wireless LAN), a wide area network (WAN), or car to X (C2X; vehicle to vehicle or vehicle to infrastructure communication). Alternatively, the communication device 18 performs communication using a global positioning system (GPS).

The communication device 18 performs these pieces of communication, thereby performing wireless communication such as acquisition or transmission of information of the outside world (infrastructure, other vehicle, and map) or information related to the own vehicle.

Alternatively, the communication device 18 includes a diagnostic terminal (OBD: On-Board Diagnostics), an Ethernet terminal, and a terminal of an external recording medium (for example, a USB memory, a memory card, or the like), and communicates with the vehicle control system 20.

In addition, the vehicle system 17 includes a vehicle control system 19 different from the vehicle control system 20. The vehicle control systems 19 and 20 may include any of a network using the same protocol and a network using protocols different from each other.

In addition, a drive unit 15 and a recognition device 16 are connected to the vehicle control system 20.

The drive unit 15 includes a machine that controls vehicle motion, an actuator that drives an electric device, and the like under the control of the vehicle control system 20. Here, examples of the machine and the electric device that control the vehicle motion include an engine, a transmission, a wheel, a brake, a steering device, and the like.

The recognition device 16 includes an external sensor such as a camera, a radar, a LIDAR, or an ultrasonic sensor, and a dynamic system sensor that recognizes a state (motion state, position information, acceleration, wheel speed, and the like) of the vehicle system 17. These sensors constituting the recognition device 16 acquire information input from the outside and generate external recognition information to be described below.

FIG. 3 shows a configuration example of vehicle control system 20 according to the present embodiment.

The network link 10 connects respective devices on the in-vehicle network. To the network link 10, a plurality of ECUs 13, a gateway (hereinafter referred to as GW) 14, and the substitution control determination device 1 are connected.

A drive unit 15 and a recognition device 16 are connected to each ECU 13 according to the ECU 13 at a corresponding position. Then, the ECU 13 controls the drive unit 15 and the recognition device 16, and acquires information from the drive unit 15 and the recognition device 16. In addition, the ECU 13 transmits and receives data to and from the network link 10. Furthermore, the ECU 13 may be connected to another network link other than the network link 10 and transmit and receive data to and from the other network link. Each ECU 13 incorporates a CPU as a calculation unit and executes various types of processing under the control of the CPU.

The gateway (hereinafter referred to as GW) 14 connects a plurality of network links 10 and transmits and receives data to and from each network link. Another network link other than the network link 10 may be connected to the GW14.

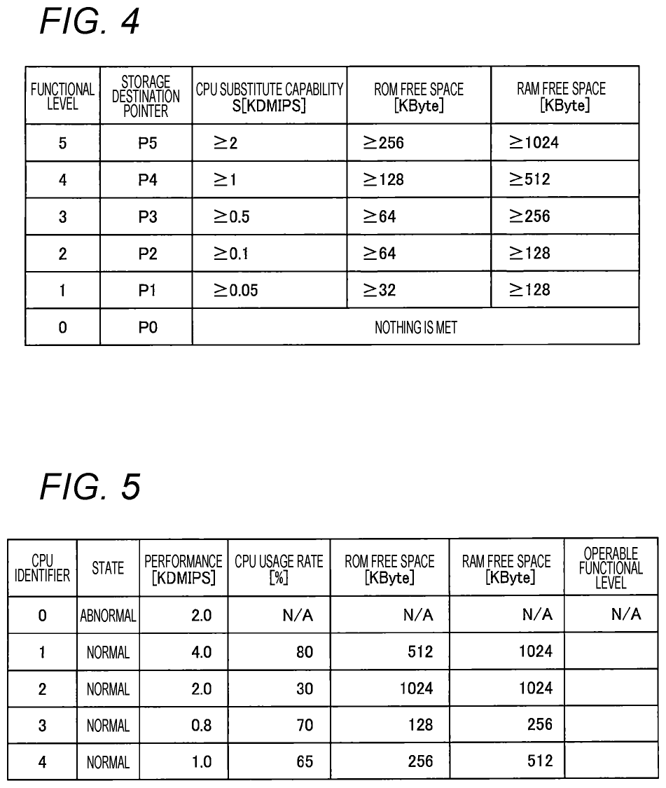

FIG. 4 shows an example of a configuration of the substitute program data table 11 provided in the substitution control determination device 1. Each of the CPUs described below indicates a CPU that is a calculation unit built in the ECU 13.

The substitute program data table 11 is created for each program assuming substitute processing. In each field of the substitute program data table 11, a program storage destination pointer for each functional level, and a CPU substitute capability, a read only memory (ROM) free space, and a random access memory (RAM) free space, which are conditions at the time of selecting the functional level, are registered. Here, the ROM free space and the RAM free space are free spaces of the ROM and the RAM connected to the CPU.

It should be noted that the ROM free space and the RAM free space described here include not only the free space of a memory element referred to as a ROM or a RAM but also the space of another memory as long as the free space is the free space of an area in which a program and the like are stored (ROM free space) or the free space of a work area used for calculation and control (RAM free space).

In the example in FIG. 4, as the functional levels, for each of the six-level functional levels of the functional levels 0 to 5, program storage destination pointers P0 to P5 different from each other are shown. Then, as the functional levels 1 to 5, minimum values of the CPU substitute capability, the ROM free space, and the RAM free space which correspond to the respective functional levels are set. The functional level 0 is a case where the CPU substitute capability, the ROM free space, and the RAM free space do not correspond to these functional levels 1 to 5.

It should be noted that here, an example has been described in which three of the CPU substitute capability, the ROM free space, and the RAM free space are associated with the functional level, but the substitute program data table 11 may be one in which at least one of the CPU substitute capability, the ROM free space, and the RAM free space is associated with the functional level.

As for the six levels of the functional levels 0 to 5, it is conceivable to perform more advanced driving support as the functional level increases. For example, the functional level 0 is a functional level that allows only manual driving without driving support, the functional level 1 is a functional level that detects a person, a vehicle, or the like and performs driving support for avoiding a collision, and the functional level 2 is a function level that performs driving support for maintaining a lane in addition to the functional level 1.

FIG. 5 shows a configuration of a substitute capability data table 12 provided in the substitution control determination device 1.

In each field of the substitute capability data table 12, a state, performance, a CPU usage rate, a ROM free space, a RAM free space, and an operable functional level for each CPU are recorded. FIG. 5 shows a state, performance, a CPU usage rate, a ROM free space, a RAM free space, and an operable functional level for each CPU, regarding the five CPUs of the CPU identifiers 0 to 4.

Among these pieces of substitute capability data, for the performance, the ROM free space, and the RAM free space, values to be input may be determined at the time of design. The CPU usage rate reflects substitute capability information acquired from each control device. The operable level is determined by the control unit 8 with reference to the data of each of the other fields and the substitute program data table.

In FIG. 5, the state of the CPU of the identifier 0 is abnormal (failure or the like), and the performance, the CPU usage rate, the ROM free space, the RAM free space, and the operable functional level are not applicable (N/A). When the CPU of the identifier 0 is abnormal in the operable state, the operable functional level indicates how much the CPU can operate.

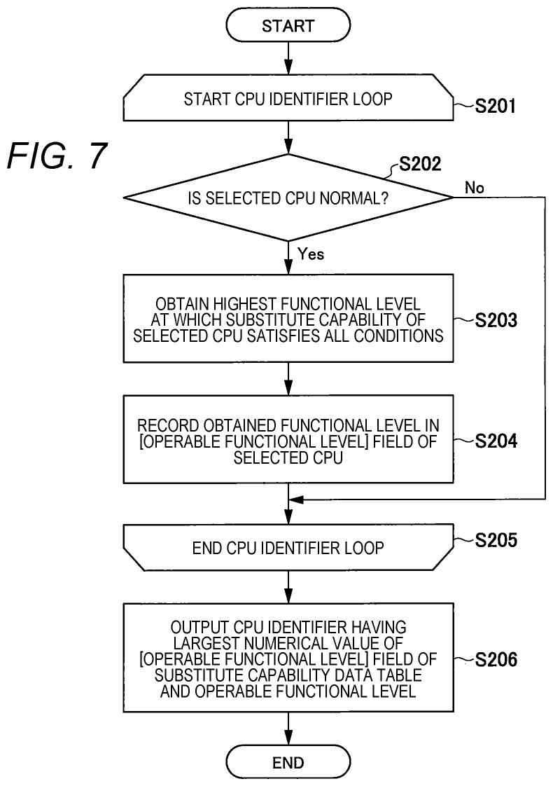

In addition, the state of the CPU of the identifiers 1 to 4 in FIG. 5 is normal, and respective values are set in the fields of the performance, the CPU usage rate, the ROM free space, and the RAM free space. The operable functional level of the CPU of the identifiers 1 to 4 is set in the processing shown in the flowchart in FIG. 7 described below.

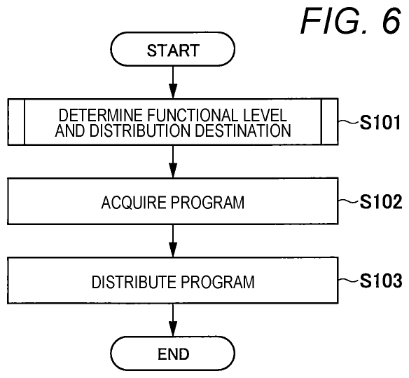

FIG. 6 is a flowchart showing processing performed by the control unit 8 of the substitution control determination device 1.

The processing in the control unit 8 is started when the control unit 8 is notified of the occurrence of abnormality from the data received by the communication unit 9, and is executed as follows.

First, the control unit 8 compares the substitute capability data table 12 with the substitute program data table 11, and determines the functional level of the substitute program and the distribution destination thereof (step S101).

Next, the control unit 8 acquires the substitute program determined in step S101 from the nonvolatile memory 4 (step S102).

Then, the control unit 8 distributes the substitute program acquired in step S102 to the distribution destination determined in step S101 (step S103).

FIG. 7 is a flowchart showing details of the processing of determining the functional level and the distribution destination in step S101 of the flowchart in FIG. 6 among the pieces of processing performed by the control unit 8 of the substitution control determination device 1.

First, the control unit 8 starts a CPU identifier loop of the substitute capability data table 12 (step S201).

Then, the control unit 8 determines whether the value of the state field of the CPU selected in step S201 matches a value indicating normal (step S202). If the value of the state field of the CPU matches the value indicating normal, the process proceeds to step S203 (step S202: Yes), and if not (step S202: No), the loop of step S201 is updated.

If the state field of the CPU is normal (step S202: Yes), the control unit 8 obtains the highest functional level satisfying the condition in each functional level on the substitute program data table 11 based on the value of the substitute capability data table 12 of the selected CPU (step S203).

Then, the control unit 8 records the functional level obtained in step S203 in the operable functional level field on the substitute capability data table 12 of the selected CPU (step S204).

The processing of steps S202 to S204 is executed in a loop for the CPUs of all the identifiers, and when the loop of the CPUs of all the identifiers is ended (step S205), the process proceeds to step S206.

In step S206, the control unit 8 outputs the CPU identifier having the largest value in the operable functional level field of the substitute capability data table 12 and the operable functional level thereof.

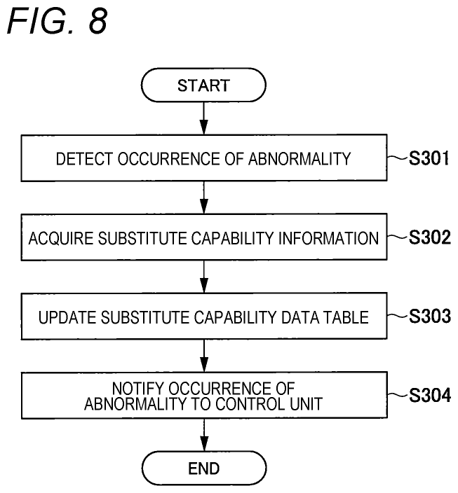

FIG. 8 is a flowchart showing processing performed by the communication unit 9 of the substitution control determination device 1.

First, the communication unit 9 detects the occurrence of an abnormality in any one of the ECUs 13 (step S301).

When detecting the occurrence of an abnormality, the communication unit 9 acquires substitute capability information of each ECU 13 connected by the network (step S302).

Next, the communication unit 9 updates the substitute capability data table 12 based on the acquired substitute capability information (step S303).

Then, the communication unit 9 notifies the occurrence of an abnormality to the control unit 8, and causes the control unit 8 to start processing (step S304).

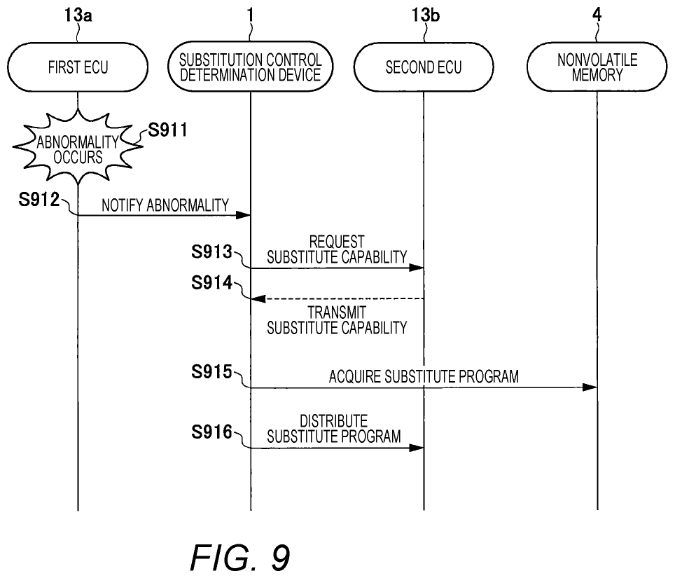

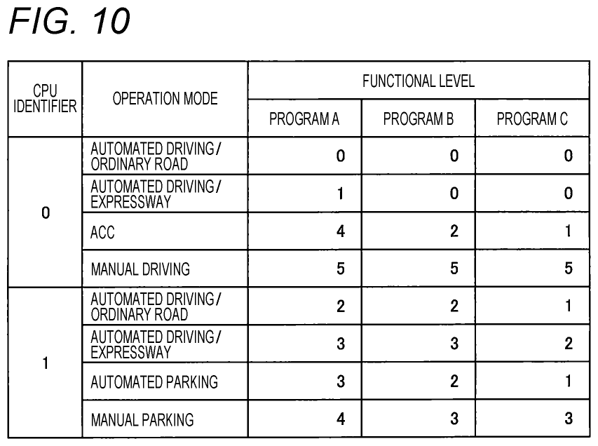

FIG. 9 shows a processing sequence of functional reconfiguration by the substitution control determination device 1.

First, an abnormality occurs in the first ECU 13a (step S911). The abnormality here also includes the occurrence of various problems such as when an apparatus such as a sensor connected to the first ECU 13a is defective in addition to when the first ECU 13a fails. As a defect of the sensor, in addition to a defect of the sensor itself, there is a case where the sensor cannot properly measure due to a factor such as weather.

The first ECU 13a in which the abnormality has occurred notifies the occurrence of the abnormality (the occurrence of the problem) to the substitution control determination device 1 (step S912).

The substitution control determination device 1 that has received the occurrence of the abnormality requests substitute capability information from another ECU (second ECU) 13b (step S913).

The second ECU 13b that has received the request for the substitute capability information transmits the substitute capability information to the substitution control determination device 1, and the substitution control determination device 1 acquires the substitute capability information (step S914).

Next, the substitution control determination device 1 acquires a substitute program from the nonvolatile memory 4 (step S915). This substitute program substitutes the program executed by the first ECU 13a from which the occurrence of the abnormality has been notified in step S912.

Then, the substitution control determination device 1 distributes the substitute program to the second ECU 13b (step S916).

The second ECU 13b stores the distributed substitute program and immediately executes the substitute program.

As described above, according to the present embodiment, when an abnormality occurs in a certain ECU, it is possible to prevent the comfort of the vehicle from being lowered more than necessary by shifting the processing to another ECU. Here, by acquiring substitute capability information indicating whether a substitute can be performed by another ECU when an abnormality occurs, it is possible to grasp a dynamic substitute capability. It should be noted that the abnormality of the ECU here includes various abnormalities such as a failure of a sensor connected to the ECU and malfunction of the sensor due to weather or the like, in addition to a failure of the ECU.

When the processing is shifted to another ECU, according to the present embodiment, by transmitting the program for performing the substitute calculation to the calculation unit satisfying the substitute capability, an appropriate program can be transmitted according to each time. That is, when there is sufficient substitute (surplus) capability of the ECU of the migration destination, a substitute program having exactly the same function as the program being executed by the ECU in which the abnormality has occurred can be stored in the ECU of the migration destination. Then, another ECU can be substituted in a state where there is no functional restriction.

On the other hand, when the capability or function of the substitute program is restricted according to the substitute (surplus) capability of the ECU of the migration destination, a certain degree of restriction is performed, but it is possible to prevent the comfort of the vehicle from being reduced more than necessary according to the capability of the substitute program.

In this case, by setting the functional level which is the level of the control content of the vehicle as indicating the substitute capability, it is possible to appropriately indicate to what extent the control of the vehicle can be substituted by using the functional level. In addition, the functional level can be easily determined by preparing the substitute program data table 11 as shown in FIG. 4 and determining the functional level with reference to the data table 11.

In addition, it is possible to select and substitute the ECU most suitable for substitution by identifying which ECU (the calculation unit thereof) is to be substituted based on the substitute capability of each ECU, transmitting the substitute program to the identified ECU, and causing the identified ECU to substitute.

In addition, by preparing the substitute program in the memory 3 in the substitution control determination device 1, the substitute program can be quickly transmitted from the substitution control determination device 1.

Furthermore, as set in the substitute program data table 11 as shown in FIG. 4, by performing calculation for obtaining the substitute (surplus) capability of the ECU of the migration destination according to the functional level that is the operation mode of the vehicle, it is easily determined how much substitute capability is required.

### Second Embodiment

Next, an in-vehicle electronic device according to a second embodiment of the present invention will be described with reference to FIGS. 10 to 12. In the second embodiment, the configuration of the substitution control determination device 1, the configuration of the vehicle system having the vehicle control system, and the network configuration to which the in-vehicle electronic device is connected are the same as those in the first embodiment.

Then, in the second embodiment, details of the processing of determining a distribution destination at the time of abnormality are different from those in the first embodiment.

FIG. 10 is a diagram showing an operation mode/substitute program functional level correspondence table according to the second embodiment of the present invention.

The operation mode/substitute program functional level correspondence table shown in FIG. 10 is a correspondence table referred to in step S101 of the flowchart in FIG. 6 of the first embodiment.

At the time of designing software to be implemented in each ECU, a processing load of each operation mode is calculated in advance, an operable level of each substitute program candidate is obtained, and data indicating a correspondence relationship therebetween is implemented.

As the operation modes here, four types are prepared, for example, an automated driving mode of an ordinary road, an automated driving mode of an expressway, a driving mode during adaptive cruise control (ACC), and a manual driving mode. It should be noted that ACC is a driving mode in which the vehicle travels following the preceding vehicle at a set speed or less.

Then, for each operation mode, the functional level is set in six levels from 0 to 5 for three of the program A, the program B, and the program C.

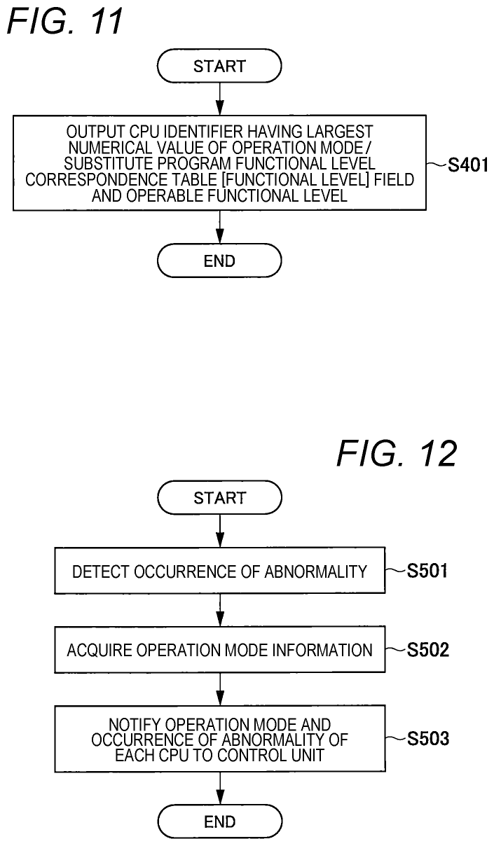

FIG. 11 is a flowchart showing an example of processing of determining a functional level and a distribution destination according to the second embodiment.

The control unit 8 refers to the operation mode/substitute program functional level correspondence table shown in FIG. 10, and outputs the CPU identifier and the functional level having the highest functional level of the substitute program among the respective CPUs (step S401). That is, the control unit 8 calculates the substitute capability of each CPU according to the operation mode of the vehicle, and outputs the CPU identifier and the functional level having the highest functional level of the substitute program. The operation mode of each CPU uses the value transmitted from the communication unit 9.

FIG. 12 is a flowchart showing an example of processing performed by the communication unit 9.

First, the communication unit 9 detects the occurrence of an abnormality in any one of the ECUs 13 (step S501).

When detecting the occurrence of an abnormality, the communication unit 9 acquires operation mode information of each CPU (step S502).

Then, the communication unit 9 notifies the operation mode and the occurrence of an abnormality of each CPU to the control unit 8, and causes the control unit 8 to start the processing (step S503).

Other configurations and processing in the second embodiment are the same as those described in the first embodiment.

According to the second embodiment of the present invention, since the execution time of the processor occupied by the calculation of the substitute capability in the first embodiment can be omitted, the function can be moved more quickly when an abnormality occurs. That is, the substitute program can be selected and transmitted according to the determined functional level, the substitute program is determined by the functional level, and the substitute program is easily determined.

### Third Embodiment

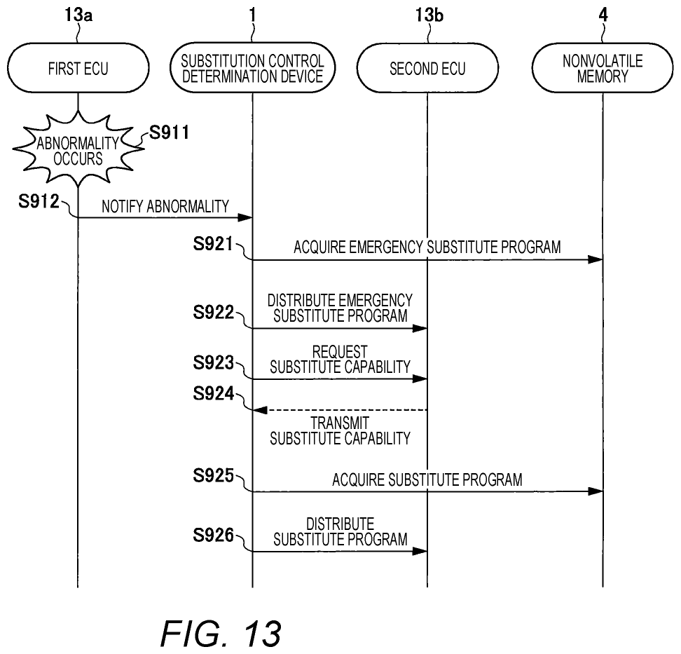

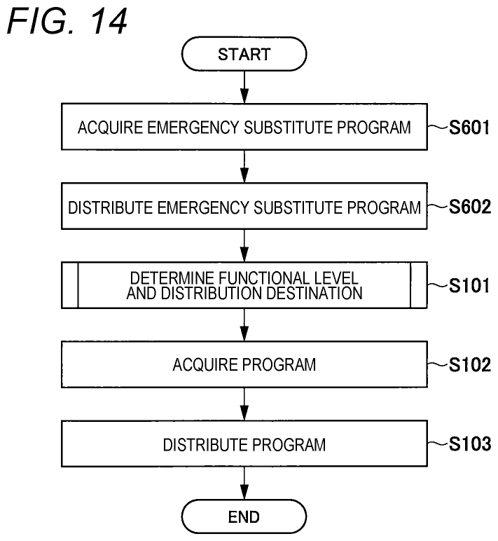

Next, an in-vehicle electronic device according to a third embodiment of the present invention will be described with reference to FIGS. 13 to 14. Also in the third embodiment, the configuration of the substitution control determination device 1, the configuration of the vehicle system having the vehicle control system, and the network configuration to which the in-vehicle electronic device is connected are the same as those in the first embodiment.

Then, the third embodiment is different from the first embodiment in the details of the processing of functional reconstruction.

FIG. 13 is a functional reconfiguration processing sequence according to the third embodiment.

First, an abnormality occurs in the first ECU 13a (step S911).

The first ECU 13a in which the abnormality has occurred notifies the occurrence of the abnormality to the substitution control determination device 1 (step S912).

The substitution control determination device 1 that has received the occurrence of the abnormality acquires the emergency substitute program from the nonvolatile memory 4 (step S921). As an example of the emergency substitute program, for example, a program for performing control to safely stop the vehicle in a roadside strip or the like when an abnormality occurs in a situation where the first ECU 13a performs control of automated driving is considered.

The substitution control determination device 1 distributes the emergency substitute program acquired in step S921 to the second ECU 13b (step S922). The second ECU 13b stores the distributed emergency substitute program and immediately executes the program.

Then, the substitution control determination device 1 requests substitute capability information from another ECU such as the second ECU 13b (step S923).

The ECU (such as the second ECU 13b) that has received the request for the substitute capability information transmits the substitute capability information to the substitution control determination device 1, and the substitution control determination device 1 acquires the substitute capability information (step S924).

Next, the substitution control determination device 1 acquires a substitute program suitable for the substitute capability from the nonvolatile memory 4 (step S925).

Then, the substitution control determination device 1 distributes the acquired substitute program to the ECU (here, the second ECU 13b) (step S926).

The second ECU 13b stores the distributed substitute program and immediately executes the substitute program.

FIG. 14 is a flowchart showing an example of processing performed by the control unit 8 according to the third embodiment.

First, when notified of the abnormality, the control unit 8 acquires the emergency substitute program from the nonvolatile memory 4 (step S601). Then, the control unit 8 distributes the emergency substitute program acquired in step S601 to another ECU (the second ECU 13b) (step S602).

Thereafter, the processing of steps S101, S102, and S103 of the flowchart in FIG. 6 described in the first embodiment is performed. That is, the control unit 8 compares the substitute capability data table 12 with the substitute program data table 11, and determines the functional level of the substitute program and the the distribution destination thereof (step S101). Then, control unit 8 acquires the substitute program determined in step S101 from the nonvolatile memory 4 (step S102). Furthermore, the control unit 8 distributes the substitute program acquired in step S102 to the distribution destination determined in step S101 (step S103).

Other configurations and processing in the third embodiment are the same as those described in the first embodiment.

According to the third embodiment described above, it is possible to distribute the substitute program at a stage before investigating the substitute capability of each ECU when an abnormality occurs. Accordingly, quick and minimum function migration is completed before substitute capability information of each ECU is acquired when an abnormality occurs. Then, it is possible to prevent the vehicle from falling into a dangerous state during the acquisition of the substitute capability information, the determination of the functional level, and the determination of the substitute program distribution destination.

### Modifications

It should be noted that the present invention is not limited to the above-described respective embodiments, and includes various modifications. For example, the above-described embodiments have been described in detail in order to describe the present invention in an easily understandable manner, and are not necessarily limited to those having all the described configurations.

In addition, in the block diagrams in FIGS. 2, 2, and 3, only control lines and information lines considered to be necessary for description are shown, and not all control lines and information lines are necessarily shown from the viewpoint of products. In practice, it may be considered that almost all the configurations are connected to each other.

Information such as programs, tables, and files that implement the functions performed by the substitution control determination device 1 can be stored in a recording device such as a memory, a hard disk, or a solid state drive (SSD), or a recording medium such as an IC card, an SD card, or a DVD.

In addition, in each of the above-described embodiments, as shown in the sequence diagrams shown in FIGS. 9 and 13, a substitute capability is requested from another calculation unit in association with the occurrence of an abnormality (the occurrence of a problem). However, the substitution control determination device 1 may acquire substitute capability information before the occurrence of a problem.

That is, the substitution control determination device 1 may acquire substitute capability information of the CPU (calculation unit) of each ECU connected via the in-vehicle network at any time (periodically or irregularly) regardless of the occurrence of a problem so as to be able to cope with the abnormal time.

However, as described in each of the embodiments described above, when the notification of the occurrence of the abnormality (the occurrence of a problem) is received, the substitution control determination device only needs to consider the substitution control only when the problem occurs by performing the processing of considering the substitution control, and as long as the problem does not occur, it is not necessary to cause the substitution control determination device to execute unnecessary processing, and the processing load on the in-vehicle network can be reduced.

In addition, in each of the above-described embodiments, the present invention is applied to an in-vehicle network in which an ECU incorporating a CPU as a calculation unit is connected by a network, but the present invention can also be applied to a device incorporating a calculation unit other than the CPU.

### REFERENCE SIGNS LIST

1 substitution control determination device
2 processor
3 memory
4 nonvolatile memory
5 I/O device
6 interconnect
8 control unit
9 communication unit
10 network link
11 substitute program data table
12 substitute capability data table
13, 13a, 13b ECU
14 gateway
15 drive unit
16 recognition device
17 vehicle system
18 communication device
19, 20 vehicle control system

1. An in-vehicle electronic device connected to a plurality of calculation units mounted on a vehicle, the in-vehicle electronic device comprising:
a communication unit configured to communicate with the plurality of calculation units; and
a control unit configured to issue an instruction of substitution control to a second calculation unit when an abnormality occurs in a first calculation unit that is one of the plurality of calculation units,
wherein when an abnormality occurs in the first calculation unit, the control unit acquires substitute capability information indicating whether the second calculation unit can substitute execution content of the first calculation unit.

2. The in-vehicle electronic device according to claim 1, wherein based on the acquired substitute capability information, the control unit determines a functional level of substitute execution content of the first calculation unit.

3. The in-vehicle electronic device according to claim 2, wherein the functional level is a level of control content of the vehicle.

4. The in-vehicle electronic device according to claim 3, wherein the control unit includes a data table that determines the functional level according to the substitute capability information.

5. The in-vehicle electronic device according to claim 4, wherein the control unit:
identifies a second calculation unit capable of substituting an execution unit of the first calculation unit based on the substitute capability information, and
transmits a substitute program for substituting an execution program of the first calculation unit to the second calculation unit through the communication unit.

6. The in-vehicle electronic device according to claim 5, wherein the control unit transmits a substitute program of the first calculation unit to the second calculation unit according to a level of the data table.

7. The in-vehicle electronic device according to claim 5, wherein the substitute program is stored in a storage mounted in vehicle in advance, and the control unit acquires a substitute program from the storage after the functional level is determined.

8. The in-vehicle electronic device according to claim 5, wherein the control unit calculates a substitute capability according to an operation mode of the vehicle.

9. The in-vehicle electronic device according to claim 6, wherein the control unit first acquires the substitute program in a state of being set to a low functional level and causes the second calculation unit to execute the substitute program based on a traveling status of the vehicle, and then, re-acquires a substitute program at a level based on the traveling status and causes the second calculation unit to execute the substitute program.

10. The in-vehicle electronic device according to claim 4, wherein the control unit determines a substitutable functional level according to at least one of a substitute capability, a ROM free space, and a RAM free space for each of the calculation units stored in the data table.

11. The in-vehicle electronic device according to claim 1, wherein when receiving a problem occurrence notification from the first calculation unit, the control unit considers the substitution control.
